(19) United States
(12) Patent Application Publication
(10) Pub. No.: US 2012/0189854 A1
(43) Pub. Date: Jul. 26, 2012

(54) ABRASION RESISTANT TRANSPARENT ARMOR

(76) Inventors: Richard L. Cook, Flagstaff, AZ (US); Edwin Slagel, Avondale, AZ (US)

(21) Appl. No.: 12/367,046

(22) Filed: Feb. 6, 2009

Related U.S. Application Data
(60) Provisional application No. 61/026,599, filed on Apr. 15, 2008.

(51) Int. Cl. B32B 27/36; B32B 37/00; B32B 27/40

(52) U.S. Cl. 428/423.7; 428/423.1; 156/60

(57) ABSTRACT

In accordance with an exemplary embodiment of the present invention, an abrasion resistant transparent armor composite may comprise an elastomer facing layer and a urethane backing layer, wherein the facing layer comprises a Shore A hardness from about 45 to about 80, a tensile strength from about 4000 to about 8000 psi., a Bashore hardness of about 46, and a softening point at least about 380° F. The elastomer may comprise a polyester based urethane polymer. Disclosed features and specifications may be variously controlled, adapted or otherwise optionally modified to improve and/or modify the performance characteristics of the abrasion resistant transparent armor composite. Exemplary embodiments of the present invention generally provide abrasion resistant transparent armor for use as, for example, a composite to layer over a vehicular window, an airplane canopy, and building windows.

### CROSS REFERENCES TO RELATED APPLICATIONS

This application claims the benefit of U.S. Provisional Patent Application No. 611026,599, filed Feb. 6, 2008, and incorporates the disclosure of such application by reference.

### GOVERNMENT LICENSE RIGHTS

The U.S. Government has a paid-up license in this invention and the right in limited circumstances to require the patent owner to license others on reasonable terms as provided for by the terms of S071-007-0028 awarded by the U.S. Department of Defense.

### BACKGROUND OF INVENTION

The preservation of transparent windows in building structures, vehicles, aircraft, and in military applications is desirable for both the security of the occupants and to avoid the financial expense of replacing damaged windows. Various transparent abrasion resistant structures for windshields and other windows have been developed that are designed to resist, inter alia, the incursion of debris from hurricanes or other weather related damage, small arms projectiles, shrapnel, debris from the road, projectiles thrown to vandalize vehicles, damage caused by dust and dirt, and/or the abrasive damage caused by frequent cleaning.

In constructing abrasion resistant and armored windows, tempered glass and plastic layers are often bonded together to form complex laminated composites. The various materials used in the layers of the composite may be chosen for their different projectile resisting characteristics and functions. Glass, polymethyl methacrylate (commonly called acrylic), and/or polycarbonate generally function to resist abrasion and damage by projectiles. The resulting composites are generally transparent and substantially free of optical distortion while maximizing the ballistic protection from various penetrators. In use, the inner and outer layers of the composite will be subjected to shock, scratching, abrasion and adverse weather conditions—particularly when a transparent armor composite is used in military applications. During the course of exposure to these damaging elements, these materials may loose their optical clarity. For example, in windows for vehicles and aircraft, the incursion of sand, dust, and debris, may cause the surface of such windows to be damaged over time.

In transparent armor for military or law enforcement applications, glass layers are hard and thus readily erode bullets and are highly abrasion resistant; however, glass layers are brittle and spall when struck by a projectile that penetrates the glass layers, producing shrapnel fragments. The shrapnel fragments are sharp and spread at a high rate of speed, a consequence that can be more dangerous to the vehicle or structure occupants than the original projectile. Plastic material layers used as part of a composite provide a means to introduce flexibility into the transparent armor composite. The addition of one or more layers of materials such as acrylic, polyurethane and/or polycarbonate to the composite alters the failure mode of the transparent armor in that it fails in a more ductile manner rather than spalling. Unfortunately, polycarbonate and the other plastic materials are soft and easily abraded by the action of dirt and dust. Further, these materials are frequently adversely affected by solvents and cleaning solutions when used to remove dirt. Thus, if plastics are used as the outer layer of a transparent armor composite, cleaning the surface dirt will inevitably cause scratching and/or etching. This causes substantial degradation of the optical clarity of the composite often in less than one year, necessitating a replacement of the composite. Since transparent armor composites are expensive, frequent replacement creates a substantial financial burden on vehicle maintenance budgets.

### SUMMARY OF THE INVENTION

In representative aspects, the present invention provides systems, devices and methods for providing bullet and abrasion resistant windows comprising a formable composite material of a polyester based elastomeric urethane polymer that is bonded or otherwise applied to a layer of high strength urethane-based backing, capable of resisting damage from projectiles and harsh environmental conditions. Advantages of the present invention will be set forth in the Detailed Description which follows and may be apparent from the Detailed Description or may be learned by practice of exemplary embodiments of the invention. Still other advantages of the invention may be realized by means of any of the instrumentalities, methods or combinations particularly disclosed herein.

### BRIEF DESCRIPTION OF THE DRAWINGS

Exemplary elements, operational features, applications and/or advantages of the present invention reside inter alia in the details of construction and operation as more fully hereafter depicted, described or otherwise identified—reference being made to the accompanying drawings, images, figures, etc. forming a part hereof (if any), wherein like numerals (if any) refer to like parts throughout. Other elements, operational features, applications and/or advantages will become apparent in view of certain exemplary embodiments recited in the disclosure herein.

FIG. 1 representatively illustrates a dual layer composite of thin elastomeric material with urethane-based backing in accordance with an exemplary embodiment of the present invention; and

FIG. 2 representatively illustrates an exemplary application of the dual layer composite in accordance with another exemplary embodiment of the present invention.

It will be appreciated that elements in the drawings, images, figures, etc. are illustrated for simplicity and clarity and have not necessarily been drawn to scale. For example, the dimensions of some of the elements in the figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms ‘front’, ‘back’, ‘top’, ‘bottom’, ‘over’, ‘under’, and the like in the disclosure and/or in the provisional embodiments, if any, are generally employed for descriptive purposes and not necessarily for comprehensively describing exclusive relative position. It will be understood that any of the preceding terms so used may be interchanged under appropriate circumstances such that various embodiments of the invention described herein, for example, are capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

In accordance with exemplary embodiments, the present invention may comprise an abrasive resistant composite comprising a relatively thin elastomeric facing that may comprise a polyester based urethane polymer layered over a high strength urethane-based backing. In an embodiment, this composite may be stretched, for example, by a heating process, to reduce its cross sectional area for subsequent forming and/or molding of the composite over another structure, such as, for example, a bullet resistant window, an airplane canopy, and the like. By subsequent cooling of the composite, the composite may harden and stiffen to a firmness similar and/or greater to, for example, a polycarbonate and/or an acrylic.

In one aspect, various representative embodiments of the present invention may be suitably configured to benefit vehicles windows. In a further aspect, other representative embodiments of the present invention may be suitably configured to benefit transparent armor useful in military vehicles, security vehicles, and aircraft. In yet a further aspect, other representative embodiments of the present invention may be suitably configured to benefit architectural structures for security or damage resistance purposes. Among various exemplary embodiments, the composite may be suitably configured to at least partially reduce friction and/or static dissipation, and/or protect from penetration by lasers.

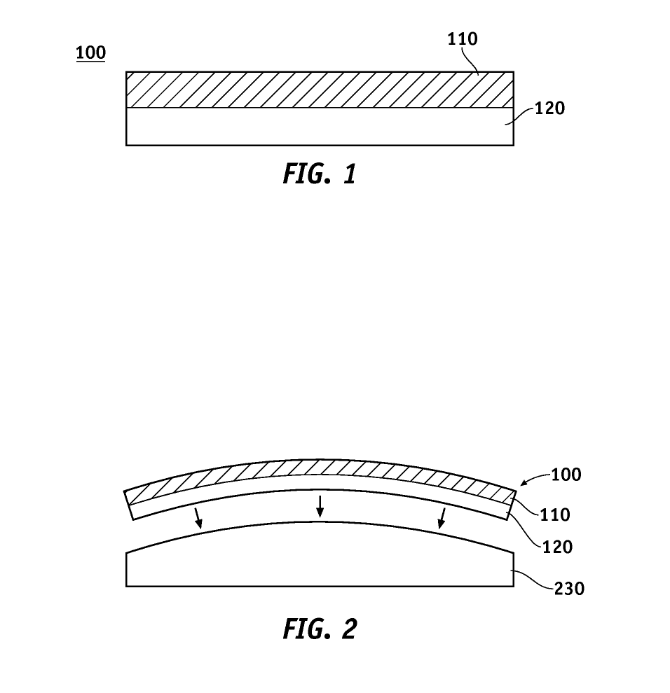

Referring now to FIG. 1, in accordance with an exemplary embodiment of the present invention, the composite 100 may comprise a backing layer 120, which may comprise one or more layers of a rigid polymer, for example, a high strength urethane-based backing. The backing layer 120 may be suitably bonded or otherwise applied to a facing layer 110, for example, with heat. In this manner, the backing layer 120 may add strength to the facing layer 110. In accordance with an alternate exemplary embodiment, the thin elastomer facing layer 110 may also be cast in, for example, a ⅜ inch thick layer and applied directly onto an existing glass armor substrate to act as an impact layer to prevent rock damage to expensive rigid armor, and the like.

In accordance with an exemplary embodiment, one or more facing layers, such as facing layer 110, may comprise a polyester-based elastomeric urethane polymer. In an embodiment, the facing layer 110 may comprise a tensile strength from about 4000 to about 8000 pounds per square inch, and may comprise, a Shore A hardness from about 45 to about 80. The facing layer 110 may further comprise a Bashore hardness of about 46, and comprise a softening point at about 380 degrees Fahrenheit. It should be appreciated among various aspects that the backing layer 120 in addition to comprising a rigid urethane, may, in some embodiments, comprise PMMA or PC. Moreover, other materials for facing layer 110 and/or backing layer 120, whether now known or otherwise hereafter described in the art, may be alternatively, conjunctively or sequentially employed to achieve a substantially similar result.

Among exemplary embodiments, the facing layer 110 may be suitably configured to comprise high rebound characteristics, and high temperature and/or ultraviolet light resistance. Moreover, the facing layer 110 may also comprise resistance to abrasion by sand, dust, windblown projectiles produced, for example, in a hurricane, abrasive cleaning, punctures, and the like.

In accordance with exemplary embodiments of the present invention, the facing layer 110 may be bonded to the backing layer 120 by any suitable method to provide composite 100. For example, in one embodiment, facing layer 110 may be bonded to backing layer 120 by pre-casting the thin elastomer facing layer 110 coating onto a mold surface which will secondarily have the rigid urethane backing layer cast against it. In another embodiment, the composite 100 may be formed by casting the thin elastomer facing layer 110 onto the rigid urethane backing layer 120 that has been pre-cured. In this manner, the thin elastomer facing layer 110 may be radically stretched, or in other embodiments formed to a wide range of finished shapes. This elastomer casting process may comprise injecting, i.e., squeezing the thin elastomer facing layer 110 between a polished cover sheet and the rigid urethane backing layer 120. In yet another embodiment, the composite 100 may be formed by forming the thin elastomer facing layer 110 sheet, that has been pre-cured, in a vacuum environment and in this environment, the thin elastomer facing layer 110 may be transferred and bonded to a contoured urethane backing layer 120. Among exemplary embodiments, forming of the composite 100 may also comprise linear and/or multi-axial forming. It should be appreciated that other forming and/or bonding processes, whether now known or otherwise hereafter described in the art, may be alternatively, conjunctively or sequentially employed to achieve a substantially similar result. Moreover, in some exemplary embodiments, stretching of the composite 100 by any suitable process may comprise a thickness reduction ratio of at least 1:11, which may further result in increased strength and stiffness (elastic modulus) of the composite 100.

In accordance with an exemplary composite, the composite 100 of facing layer 110 and backing layer 120 may be stretched and/or formed, through a heating process, as described, and applied over structures such as glass, transparent polymer windows, and/or a wide range of finished shapes. For example, and with reference to FIG. 2, the composite 100 may be suitably elongated for application to an existing structure, for example, an airplane canopy 230 and other like structures. It should also be appreciated, in accordance with various aspects of the present invention, that the composite 100 may also be molded, shaped, and/or otherwise formed over previously damaged windows, glass armor and/or the like. In one embodiment of the present invention, the composite 100 may at least partially restore optical qualities and reduce and/or negate the need to replace damaged windows and/or glass armor.

In accordance with exemplary embodiment, it should be appreciated that the composite 100 comprises a transparent structure and does not detract from the optical transmissive properties of the application that the composite 100 may be applied to. In some embodiments, the composite 100 may comprise additional U-V coatings, and/or tinting. In this manner it may provide supplemental benefits to the specific application.

In accordance with exemplary embodiments of the present invention, once the composite 100 is formed, it may be applied to the intended application, such as a vehicle window, an airplane canopy, etc., by various processes. For example, the composite 100 may be applied to an application by similar processes described to bond the facing layer 110 to the backing layer 120, but in other embodiments, the composite 100 may be applied to an application by using an adhesive, for example, a contact adhesive, a wet adhesive and the like.

Particular implementations shown and described herein are illustrative of the invention and its best mode and are not intended to otherwise limit the scope of the present invention in any way. Indeed, for the sake of brevity, prepolymers, diamine curing agents, polyurethanes, polyureas and/or the like may not be described in complete detail herein.

In the foregoing specification, the invention has been described with reference to specific exemplary embodiments; however, it will be appreciated that various modifications and changes may be made without departing from the scope of the present invention as set forth in the exemplary provisional embodiments. The specification and figures are to be regarded in an illustrative manner, rather than a restrictive one and all such modifications are intended to be included within the scope of the present invention. Accordingly, the scope of the invention should be determined by the provisional embodiments and their legal equivalents. For example, the steps recited in any method or process embodiments may be executed in any order and are not limited to the specific order presented in the provisional embodiments. Additionally, the components and/or elements recited in any apparatus embodiment may be assembled or otherwise operationally configured in a variety of permutations to produce substantially the same result as the present invention and are accordingly not limited to the specific configuration recited in the provisional embodiments.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the provisional embodiments.

As used herein, the terms “comprising”, “having”, “including”, or any contextual variant thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

we claim:

1. An abrasion resistant transparent armor composite comprising:
an elastomer facing layer; and
a urethane backing layer.

2. The composite of claim 1, wherein the facing layer comprises a Shore A hardness from about 45 to about 80.

3. The composite of claim 1, wherein the facing layer comprises a tensile strength from about 4000 to about 8000 psi.

4. The composite of claim 1, wherein the facing layer comprises a Bashore hardness of about 46.

5. The composite of claim 1, wherein the elastomer comprises a polyester based urethane polymer.

6. The composite of claim 1, elastomer comprises a softening point at least about 380° F.

7. The composite of claim 1, wherein the composite further comprises at least one of a U-V coating and a tinting.

8. An abrasion resistant system comprising:
a transparent structure; and
a composite comprising an elastomer facing layer suitably coupled to a urethane backing layer.

9. The system of claim 8, wherein the facing layer comprises a Shore A hardness from about 45 to about 80.

10. The system of claim 8, wherein the facing layer comprises a tensile strength from about 4000 to about 8000 psi.

11. The system of claim 8, wherein the facing layer comprises a Bashore hardness of about 46.

12. The system of claim 8, wherein the elastomer comprises a polyester based urethane polymer.

13. The system of claim 8, elastomer comprises a softening point at least about 380° F.

14. The system of claim 8, wherein the composite further comprises at least one of a U-V coating and a tinting.

15. The system of claim 8, wherein the structure comprises at least one of an airplane canopy, a vehicle window, and a building window.

16. A method for manufacturing an abrasion resistant material comprising:
providing an elastomer facing layer; and
bonding a urethane backing layer to the facing layer.

17. The method of claim 16, wherein the facing layer comprises a Shore A hardness from about 45 to about 80.

18. The composite of claim 16, wherein the facing layer comprises a tensile strength from about 4000 to about 8000 psi.

19. The composite of claim 16, wherein the facing layer comprises a Bashore hardness of about 46.

20. The composite of claim 16, wherein the elastomer comprises a polyester based urethane polymer.
